(19) United States
(12) Patent Application Publication
(10) Pub. No.: US 2007/0288531 A1
(43) Pub. Date: Dec. 13, 2007

(54) Mobile device with an embedded file system capable of updating file system components

(76) Inventor: Giovanni Motta, Laguna Niguel, CA (US)

Correspondence Address: Kevin Borg;McAndrews, Held & Malloy, Ltd., 500 W. Madison St., Chicago, IL, 60661, US

(21) Appl. No.: 11/449,259

(22) Filed: Jun. 7, 2006

(51) Int. Cl. G06F 17/30

(52) U.S. Cl. 707/203

(57) ABSTRACT

A file system based OS, such as CRAMFS, is employed in an electronic device. These OS are embedded in some electronic devices and the file systems have particular behavioral characteristics in these electronic devices embedded OS. Updating files in such file system requires the use of heuristics that help manage the update process. For example, heuristics is used to conduct efficient garbage collection in the device as part of the update process, in a preprocessing step.

### FEDERALLY SPONSORED RESEARCH OR DEVELOPMENT

Not Applicable

### MICROFICHE/COPYRIGHT REFERENCE

Not Applicable

The present application claims priority to, and is based on, provisional U.S. patent application entitled “MOBILE DEVICE WITH AN EMBEDDED FILE SYSTEM CAPABLE OF UPDATING FILE SYSTEM COMPONENTS”, filed Jun. 07, 2005, which is hereby incorporated by reference in its entirety.

### BACKGROUND OF THE INVENTION

1. Field of the Invention

The present invention relates generally to the process of determining and fixing problems with devices in an operator's network, and, more specifically, to the firmware and software updates of mobile devices.

2. Related Art

Electronic devices, such as mobile phones and personal digital assistants (PDA's), often contain firmware and application software that are either provided by the manufacturers of the electronic devices, by telecommunication carriers, or by third parties. If firmware or firmware components are to be changed in electronic devices, it is often very tricky to update the firmware components.

It is often difficult to determine what is wrong with a device when a problem is encountered. Quite often, a customer care representative for an operator does not have answers to a customer's problem and is not able to fix it. Determination of problems with a customer's mobile device is a big problem for operators. Answering customer care calls is quite expensive. Especially so if at the end of such a call, the customer care representative is unable to determine what is wrong with the device.

CRAMFS (cram a File System onto a small ROM) is a file system structure suitable for embedded devices. It consists of a directory section containing file names, properties and pointers to the physical locations of the files and a file section, where the information associated with the files is actually stored [1]. In order to contain overhead, this structure is kept very simple. To save space and increase efficiency, unlike most disk oriented file systems, CRAMFS assumes that the files are stored contiguously in memory.

Updating mobile devices with a file system, such as CRAMFS, is a problem. There is a problem of minimizing the movement of files when the file system is being updated. If there is sequence of files laid out contiguously that need to be updated, is if even one of the files in a sequence needs to be updated, due to the avalanche effect, other files get effected. There are no clear and easy mechanisms by which such embedded file systems can be updated.

### BRIEF SUMMARY OF THE INVENTION

The present invention is directed to apparatus and methods of operation that are further described in the following Brief Description of the Drawings, the Detailed Description of the Invention, and the Claims. Features and advantages of the present invention will become apparent from the following detailed description of the invention made with reference to the accompanying drawings.

### BRIEF DESCRIPTION OF THE DRAWINGS

FIG. 1 is a perspective block diagram of a network that is capable of updating electronic devices some of which are based on embedded file systems;

FIG. 2 is a schematic diagram of an instance of preprocessing applied to the file system of an electronic device as a software component comprising multiple files is being updated;

FIG. 3 is a Table that shows the results obtained on 7 versions of a sample CRAMFS file system;

FIG. 4 shows the amount of bytes moved by the Basic and Greedy GC techniques for increasing memory sizes when updating versions 0 to 1 and 1 to 2;

FIG. 5 shows the amount of bytes moved by the Basic and Greedy GC techniques for increasing memory sizes when updating versions 0 to 1 and 1 to 2, wherein the bytes moved is shown as a percentage of minimum memory;

### DETAILED DESCRIPTION OF THE INVENTION

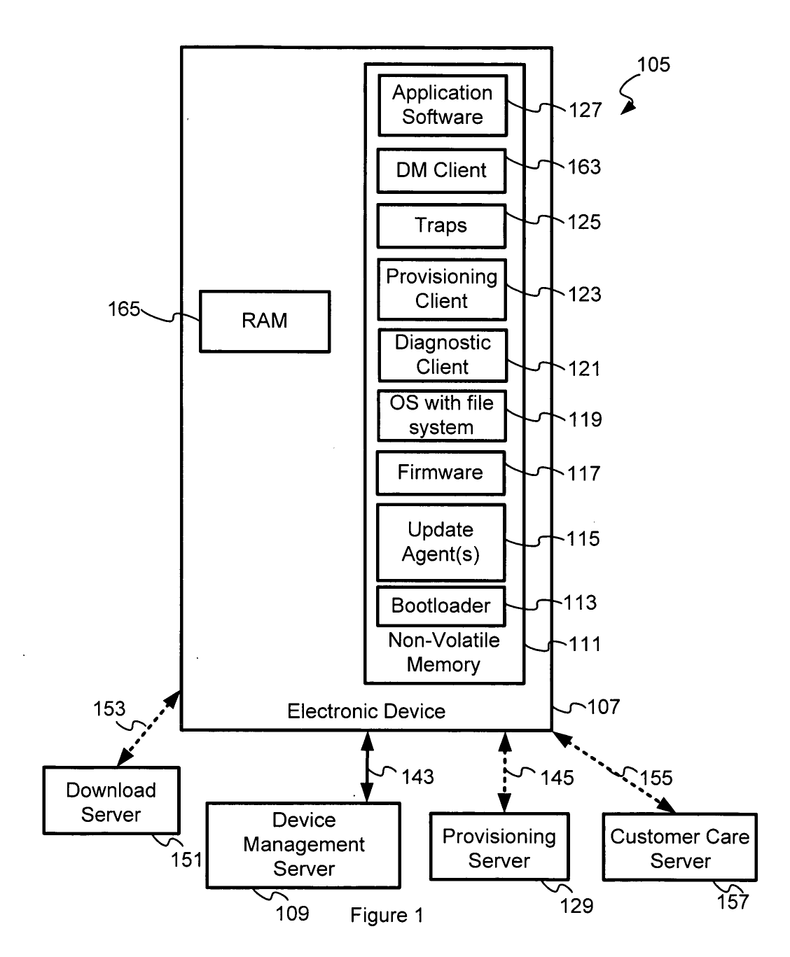

FIG. 1 is a perspective block diagram of a network that is capable of updating electronic devices some of which are based on embedded file systems. The network 105 is capable of mass distribution of firmware and software updates to fix problems that have been diagnosed with mobile devices. The network 105 comprises a device management (DM) server 109, a customer care server 157, a download server 151, an electronic device 107 and a provisioning server 129. The electronic device 107 is capable of updating an application software 127, an operating system (OS) 119, or a firmware 117 in the electronic device 107 employing an update package delivered by the download server 151. It is also capable of receiving provisioning information from the customer care server 157 or the provisioning server 129 to fix configuration problems or reconfigure software and hardware. The electronic device 107 is capable of applying updates using one or more update agents 115 that are each capable of processing update packages or subsets thereof. The electronic device 107 is capable of receiving update packages. It comprises the update agent(s) 115 that is capable of updating the electronic device 107, a diagnostic client 121 that facilitates remote diagnosis and a traps client 125 that facilitates setting traps and retrieving collected information. The electronic device 107 also comprises a DM client 163 that is capable of interacting with the provisioning client 123, the diagnostic client 121 and the traps client 125.

The electronic device 107 comprises the OS 119, which is an embedded file system. In one embodiment, it is a file system where the individual files are stored in a contiguous manner. In a related embodiment, the OS is CRAMFS based, and has a directory and a plurality of files, file1, file2, etc. Update of a file in the file system supported by the CRAMFS based OS 119 takes into account the need to keep the files contiguous. In particular, a version of the update agent 115 is capable of updating the CRAMFS based OS 119 components using heuristics that help in minimizing the movement of files while during the update of a file or file system components. Using these heuristics, an efficient mechanism to update one or more files in the file system is implemented.

In a related embodiment, a preprocessing step in a electronic device, that is capable of consuming update packages for CRAMFS based file systems, maximizes the available empty space (free space) in the CRAMFS based file system managed by the OS 119. The preprocessing step employs one of two heuristics—a basic one and another which is an improved version that will reduce the movement of files. The preprocessing step conducts some sort of garbage collection (GC) in the electronic device. In the basic GC approach, the first big free space is targeted to be used to update a file.

In one related embodiment, the first greedy, second greedy and improved greedy heuristics are implemented in the electronic device. The generator does not need to know the heuristics, only the electronic device uses them. The generator uses a logical view of the files, not physical layouts. The electronic device does all the movement of the blocks for a particular file as it is being updated. An encoder can simulate the heuristics and deterministically know the layout, if needed.

In one embodiment, the same update 115 is used for updating firmware 117 as well as components of the OS 119, or components in a file system employed by the OS 119. In another embodiment, file system components managed by the OS 119 are updated by a different update agent 115 than the update agent 115 employed to update the firmware 117 and the OS components 119 itself. Thus, there are more than one update agent 115 used in the device 107 in this embodiment.

In one embodiment, a file system based OS 119, such as Linux with the CRAMFS file system, is employed in the electronic device 107. These OS 119 are embedded in some electronic devices 107 and the file systems have particular behavioral characteristics in these electronic devices 107 embedded OS 119. Updating files in such file system requires the use of heuristics that help manage the update process. For example, heuristics are used to conduct efficient garbage collection in the device as part of the update process, in a preprocessing step.

The electronic device 107 is capable of applying updates to firmware or to file system components using one or more update agents 115 that are each capable of processing update packages or subsets thereof. For example, a firmware update agent 115 is used to update the firmware 117 and a component update agent is used to update a file system component that resides in the OS with file system 119. Each update agent consumes a different update package for its update. In a related embodiment, a combined update agent 115 is capable of updating both the firmware 117 as well as the file system components that reside in the OS with file system 119. In this case, the combined update agent 115 consumes a different update package, one for the firmware 117 update and another for the file system component update in the OS with file system 119.

The DM client 163 typically received DM commands from the DM server 109 and implements them. The download server 151 is used to download firmware and software updates. A customer care server 157 facilitates access to the information in the device by customer care representatives (CSR). A provisioning server 129 facilitates communication of provisioning information, over the air (OTA), to the electronic device 107.

CRAMFS (cram a File System onto a small ROM) is a file system structure suitable for embedded devices. It consists of a directory section containing file names, properties and pointers to the physical locations of the files and a file section, where the information associated to the files is actually stored. In order to contain overhead, this structure is kept very simple. To save space and increase efficiency, unlike most disk oriented file systems, CRAMFS assumes that the files are stored contiguously in memory; a file of M bytes will start at memory location K and end at memory location K+M−1. This characteristic, crucial in the present invention, is also common to other embedded file systems. Thus, while the present invention is described here with reference to CRAMFS file system most considerations will apply to other file system formats as well.

The main assumption made in the present invention is that the memory image being updated is composed by a directory and several files. At the end of an update, the logical structure of the file system is preserved, while the relative or absolute position of the files in the RO memory is of little or no importance. The bytes in each file have to be physically contiguous, so if the space to update a file is not contiguously available, some form of defragmentation (or garbage collection) is required. The present invention addresses the problem of defragmentation as it applies to CRAMFS and suggests some low complexity greedy techniques that are implemented directly on the device.

Another important assumption made in the present invention is that at the end of an update, the logical structure of the file system is the main information that has to be preserved, while the relative or absolute position of the individual files in memory is of little or no importance.

In accordance with the present invention, the update process works by replacing the new versions of the files, one by one. Each new file is first reconstructed by using the old (reference) version, then the reference version is deleted and the space previously occupied is made available for the next update. Since the bytes in each file have to be physically contiguous, if at any moment the largest contiguous empty space is smaller than the size of the file being updated, some form of defragmentation (or garbage collection) is performed. The present invention also incorporates the impact of defragmentation. Finally, a low complexity greedy technique is selectively implemented directly on the device.

The file system of the mobile device 107 consists of n files of lengths. These files have to be replaced by n files of lengths l*₁, l*₂, . . . . Throughout the update of the i-th file we assume that the reference copy lᵢ must be present in memory at all times, at least until is fully reconstructed. After that, the space occupied by l₁ can be freed and used for further updates. In order to start the process it is necessary that a block of empty memory is available at the beginning of the update. We will refer to this empty block by calling it E.

The lengths of the new files can be greater, smaller or equal to the lengths of the corresponding reference versions. The update of files that have been added in the new version (V₂) and files that have been deleted from the old version (V₁) can be modeled by assuming that for some i, Iᵢ=0 and l*ᵢ≠0 (i-th file is new in V₂ and has no correspondent reference in V₁) or Iᵢ≠0 and l*ᵢ=0 (i-th file has been deleted from V1 and has no correspondent in V₂).

Without loss of generality, it has been assumed that the reconstruction of each file depends on one reference version only; also in order to abstract on the problem of defragmentation, the issues related to the update of compressed files (buffering, memory requirements, etc. . . . ) are assumed to exist and associated mechanisms are employed as / if needed.

Preprocessing by comparing files between the old version and the new version makes it possible to determine the nature of changes to individual files and if there is any need to selectively defragment specific files. A number of simple operations are performed right at the beginning of the update process in order to maximize availability of empty space. The same operations have also the benefit of reducing the number of available cases and simplify the notation used in this document. In the following, it can be safely assumed that a package update will start with the following operations:

1. Find in V₁ and V₂ all file pairs such that lᵢ≠0 and l*ᵢ=0. Since these files have no correspondent in V₂, they can be deleted from V₁ in order to free memory space.

2. Find in V₁ and V₂ all file pairs such that lᵢ=l*ᵢ. If the file contents are different, as long as l*ᵢ≦E these files can be updated without requiring any defragmentation.

3. Find in V₁ and V₂ all file pairs such that lᵢ>l*ᵢ. These are files that shrunk in V₂. As long as l*ᵢ≦E these files can be updated and after that, the difference lᵢ−l*ᵢ marked as empty memory space, available for further updates. Even in this case, no defragmentation will be necessary.

At the end of the steps 1-3 we are left with the task of updating all files for which lᵢ<l*ᵢ, i.e. all files that have larger size in V₂ than in V₁. Only for these files defragmentation might be required.

Preprocessing files to determine how they have changed between versions and to determine if any files needs to be defragmented during the update process allows a formulation of the problem that is simpler and makes more evident the relations between the various parameters of an instance.

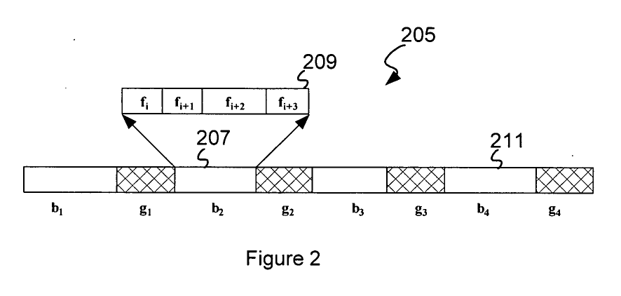

FIG. 2 is a schematic diagram of an instance of preprocessing applied to the file system 205 of an electronic device as a software component comprising multiple files is being updated. The non-volatile memory image, such as FLASH memory, for the file system comprises several blocks of file content b1, b2, b3, b4, with gaps between some of the blocks g1, g2, g3, g4. The instance 211 of the non-volatile memory image where the preprocessing activity is conducted for updating a multiple file software component (a software component with multiple files in the file system) consists of the following integer parameters, each expressed in bytes:

The file length of N “reference” files f₁,f₂, . . . , f_{N};

The file length of N “new” files f*₁,f*₂,. . . , f*_{N} that will replace the references at the end of the update;

A memory image consisting of K empty blocks (gaps) each of size g₁,g₂, . . . , g_{K} interleaved by K occupied blocks of size b₁,b₂, . . . , b_{K}.

Since the formulation of this instance follows the preprocessing activity, we have that fᵢ<f*ᵢ for 1≦i≦N. By using the formalism just introduced, it is possible to state some conditions under which the update can be carried on with or without the need for defragmentation.

Observation 1: If N>0 then we need some empty space in order to restore the files f*₁,f*₂, . . . , f*_{N}. Trivially, the update is not possible if:

$${\sum }_{i = 1}^{N} {f}_{i} + {\sum }_{i = 1}^{K} {g}_{i} < {\sum }_{i = 1}^{N} {f}_{i}^{*}$$

With reference to the empty block E mentioned earlier:

$${\sum }_{i = 1}^{n} {f}_{i}^{*} - {\sum }_{i = 1}^{n} {f}_{i} = {\sum }_{i = 1}^{n} ( {f}_{i}^{*} - {f}_{i} ) \leq E$$

Observation 2: If gₘₐₓ is the size of the largest gap and f*ₘᵢₙ is the size of the smallest file waiting to be updated, then defragmentation is necessary when:

gₘₐₓ<f*ₘᵢₙ

Observation 3: If f*₁≦f*₂≦ . . . ≦f*_{N}, g₁≦ . . . ≦g_{K}, K≧N and for 1≦i≦N

f*ᵢ≦gⱼ

then defragmentation is not necessary at any stage of the update. The same happens when

$${\sum }_{i = 1}^{N} {f}_{i}^{*} \leq {g}_{max}$$

Among all possible solutions, the solution sought is one that does the smallest possible amount of defragmentation, measured in terms of the occupied bytes moved in order to merge the empty blocks. Since the solution should be implemented on the device, complex optimal techniques are not considered here; instead simple greedy heuristics are employed in the present invention.

In one embodiment, the problem addressed is one of determining, given a specific instance, what is the minimum amount of memory that is sufficient in order to complete the update without defragmenting. Specifically, one of three greedy strategies to select the update order are employed—first fit, best fit and best-pair:

First Fit: After the preprocessing, the files f*₁, f*₂, . . . , f*_{N} are sorted in decreasing order. The largest file f*ₘₐₓ fitting the largest empty gap gₘₐₓ is updated and a new gap of size gₘₐₓ−f*ₘₐₓ is created. The process is iterated until all files are updated. For all the successful updates the one with the smallest E is selected.

Best Fit: After the preprocessing, the files f*₁F*₂, . . . ,f*_{N} are sorted in decreasing order. The largest file f*ₘₐₓ is updated by using the smallest gap g_{best} having equal or bigger size: g_{best}=arg min (gᵢ−f*ₘₐₓ). After the update a new gap of size g_{best}−f*ₘₐₓ is created. The process is iterated until all files are updated. For all the successful updates the one with the smallest E is selected.

Best Pair: At each round, a pair (f*_{bp},g_{bp}) is selected so that g_{bp}−f_{bp} is minimum among all possible pairs. After updating the file f*_{bp} a new gap of size g_{bp}−f*_{bp} is created. The process is iterated until all files are updated. For all the successful updates the one with the smallest E is selected.

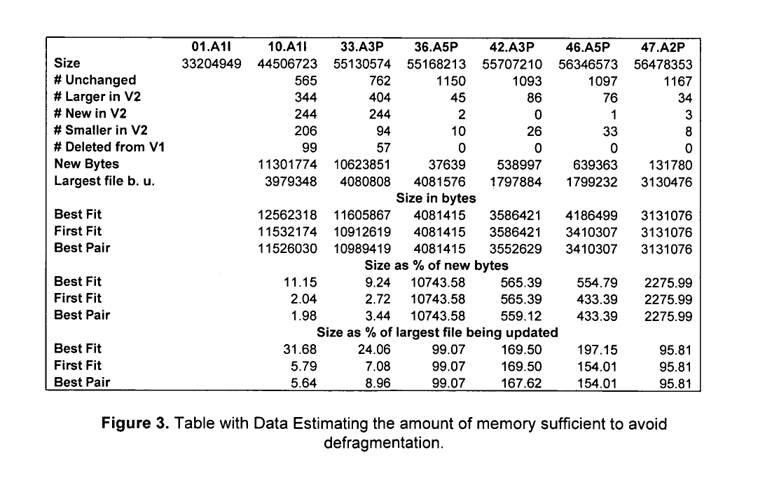

FIG. 3 is a Table that shows the results obtained on 7 versions of a sample CRAMFS file system. The data was obtained from update activities wherein the update was always performed in order to go from one version to the successive. When the problem does not present a degenerate instance (in which all techniques are equivalent and the final answer depends on a single large file) the last two have superior performance, with Best Fit being simpler to implement. In all update scenarios presented in the table of FIG. 3, an empty memory block E 1.7 times larger than the largest file being updated would have been sufficient to complete the update without need for any defragmentation.

The present invention provides a technique of estimating the amount of defragmentation for a given E. In a more interesting embodiment, the size of the initial empty block E is fixed and the minimum amount of defragmentation necessary to complete the update with a greedy strategy that selects the file ordering is estimated.

The performance is measured by counting the number of bytes moved during the defragmentation. While the results of the comparison are likely to be still valid under other assumptions, in a more realistic setting, counting the number of blocks copied may be more relevant to the estimate of the update speed.

The performances of three greedy garbage collection techniques when compared on the data set used in the previous experiment reveal the efficacy of these approaches under specific conditions. The memory image is updated by using the technique described before as Best Fit and when the largest block of contiguous empty memory is not big enough to host the current file, one of three techniques is invoked:

Basic GC: The memory blocks are scanned from the lowest to the highest index. Once the first empty block is located, the empty memory is “bubbled up” until a new empty block is found. The two blocks are then merged and the process iterated until the empty block is big enough to contain the new file. If the empty block is larger than the file, after the update, the remaining empty bytes are placed after the file.

Greedy GC: The whole memory image is scanned and for every sequence of t empty blocks gᵢ,gᵢ₊₁, . . . ,gᵢ₊ₗ₋₁ interleaved by t−1 blocks of occupied memory bᵢ, bᵢ₊₁, . . . , bᵢ₊ₜ₋₂ such that

$${\sum }_{j = i}^{i + i - 1} {g}_{j} \geq {f}_{max}^{*}$$

a cost function Cᵢ is computed as

$${C}_{i} = {\sum }_{j = i}^{i + i - 2} {b}_{j} / {\sum }_{j = i}^{i + i - 1} {g}_{j}$$

The cost Cᵢ represents the number of bytes that have to be moved for each empty byte. The technique merges the t empty blocks gᵢ,gᵢ₊₁, . . . ,gᵢ₊ₗ₋₁ for which the cost Cᵢ is minimum.

Improved Greedy GC: The basic criterion is the same as Greedy GC, but in order to avoid multiple relocations of the same occupied blocks, the occupied blocks are divided in two groups: blocks corresponding to files that have already been updated and blocks that correspond to files that haven't been updated yet.

At the end of the garbage collection, the section of blocks involved will consist first of all blocks of the first group as shown in image B of FIG. 6. An empty space sufficient to the storage of f*ₘₐₓ will follow. Then the blocks of the second group and finally an empty block of size.

$${\sum }_{j = i}^{i + i - 1} {g}_{j} - {f}_{max}^{*}$$

The rationale behind this arrangement is that the blocks belonging to the second category will be freed in the future and will generate empty memory blocks, so it is better not to interleave them with blocks in the first group. If the file being updated is among the occupied blocks, at the end of the garbage collection, it should be moved at the very top so that after its deletion, its space can be merged to the empty block (see memory layout C and D of FIG. 6).

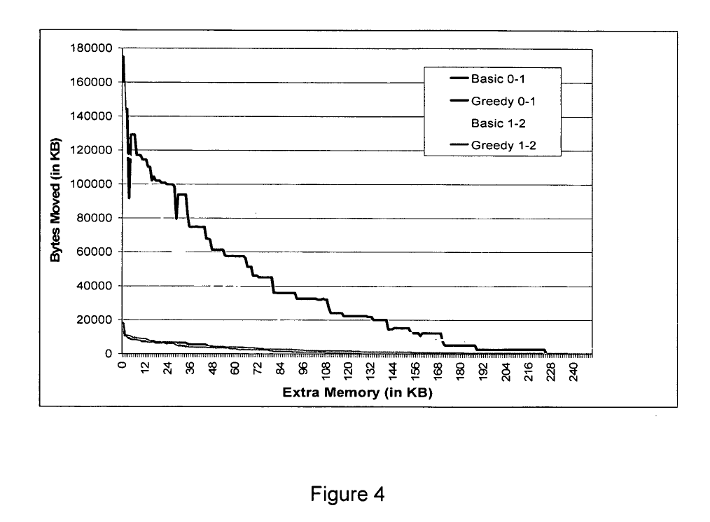

FIG. 4 shows the amount of bytes moved by the Basic and Greedy GC techniques for increasing memory sizes when updating versions 0 to 1 and 1 to 2.

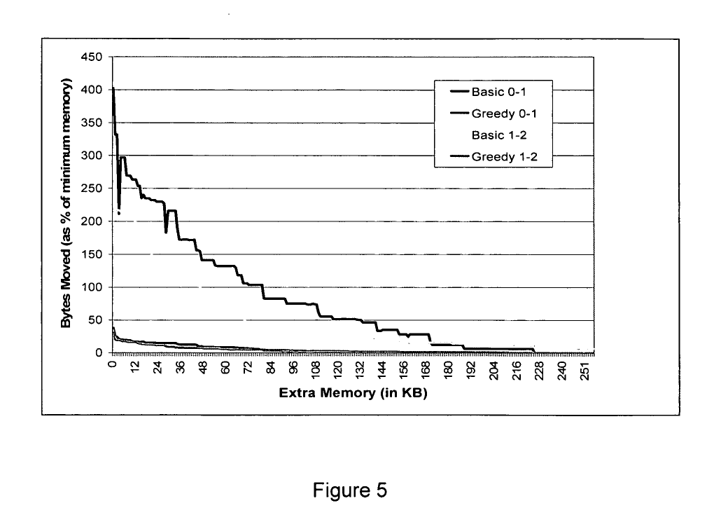

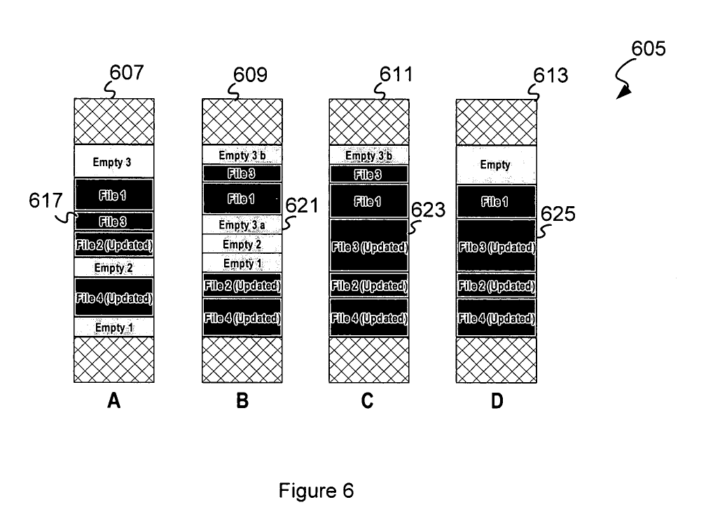

FIG. 5 shows the amount of bytes moved by the Basic and Greedy GC techniques for increasing memory sizes when updating versions 0 to 1 and 1 to 2, wherein the bytes moved is shown as a percentage of minimum memory.

FIGS. 4 and 5 shows the amount of bytes moved by the Basic and Greedy GC techniques for increasing memory sizes when updating versions 0 to 1 and 1 to 2. In the FIG. 4, both extra memory and bytes moved are expressed in KB. The extra memory is the quantity of memory that is added to the maximum between the largest file being updated and the difference in bytes between V₁and V₂, i.e. the memory in excess to the minimum quantity necessary to complete the update. The FIG. 5 expresses the bytes moved in terms of % with respect the minimum quantity of memory necessary to complete the update.

In one embodiment, the Improved Greedy GC has performance that is better than Greedy GC.

FIG. 6 is a perspective block diagram showing the update process in accordance with the present invention wherein the technique of Improved Greedy GC is employed. It shows the update of a File 3 that involves empty block compaction during the update. Specifically, four different file system states are shown that occur during the process of updating the File 3—before update of File 3 (A) 617, after empty blocks compaction (B) 621, after update (C) 623, after deleting old version (D) 625.

Image A 607 shows that File 3 617 needs to be updated and empty spaces Empty1 and Empty2 are available. In addition Empty space Empty 3 is available too. Image B 609 shows that File 4 that is updated, is moved down so as to get Empty 1 and Empty2 adjacent to each other thereby creating a greater contiguous empty space available, one that is appropriate for the new version (updated version) of File 3. For fault tolerance, File 3 is backed up in the greatest empty space available, which happens to be Empty 3 in this scenario. Also notice that updated File 2 is moved adjacent to updated File 4 to further provide for compaction of used areas of the file system and aggregation of empty file spaces. In addition, a leftover empty space from Empty 3, labeled Empty 3b, is created and tracked.

Image C 611 shows the results after the update of the File 3 and the creation of the updated File 3 623. The backup of original version of File 3 exists and that is the target of the next phase of aggregation wherein Empty 3b and File 3 (old un-updated version used as backup for fault tolerance) are merged into a larger empty space. Image 4 shows the image of the file system 613 after the deletion of the older version of File 3 and the aggregation of its space into a larger Empty space.

When supported by an appropriate data structure, the Greedy and the Improved Greedy GCs are simple enough to be implemented directly on the device. Such implementation would be extremely beneficial since it will implement a “true” file-based update in which the logical and not the physical consistency of the file system is enforced.

Furthermore the encoder does not need to keep track of the physical position of all files in order to generate an update package. This is important because the memory configuration generated by an update V₁→V₂ followed by V₂→V₃ is generally different from the result of the update V₁→V₃. If the garbage collection is pre computed during the generation, the generator has to build two different packages V₃→V₄, one suitable for devices that have been updated directly from version 1 to 3 and the other for devices that went through the two-step update. This may create problems of version tracking and version verification (before sending the correct update package to the device).

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method of modifying an electronic device with a file system from a first version V₁ to a second version V₂, the file system comprising a plurality of files, the method comprising:
preprocessing files in version V₁; and
selectively Updating files in version V₁.

2. The method of claim 1 wherein preprocessing comprises:
determining files among the plurality of files that occur in the first version V₁ and not in the second version V₂ and deleting them from the first version V₁ in order to free memory space.
locating files among the plurality of files in version V₁ and in version V₂ that are of the same size and replacing the file from version V₁ without requiring any defragmentation with the corresponding file from version V₂ if the file contents are different; and
finding files in the first version V₁ and second version V₂ wherein the files are shrunk in the second version V₂, and changing them.
defragmenting selectively a portion of the file system for manipulating files from the first version V₁ that are larger in size in the second version V₂ than in the first version V₁.

3. The method of claim 2 wherein the file system comprises a plurality of gaps and wherein defragmenting occurs only when the size of the largest gap among the plurality of gaps currently available is less than the size of the smallest file that currently needs to be updated.

4. The method of claim 2 wherein the file system comprises a plurality of gaps and wherein defragmenting does not occur when the number of available gaps in the plurality of gaps is greater than the number of files to be updated and the size of the new updated version of each of the files is less than a corresponding one of the gaps.

5. A method updating multiple files in a file system wherein a file is selected for updating in a iterative loop if it is expected to cause the smallest possible amount of defragmentation, measured in terms of the occupied bytes moved in order to merge the empty blocks currently available in the file system.

6. A method for managing files in a file system, the file system comprising multiple files and at least one file that needs to be updated, the method comprising:
preprocessing files among those of the at least one file that needs to be updated; and
updating the rest of the at least one file that needs to be updated, if any.

7. The method of managing files according to claim 6 wherein updating comprises selectively employing one of a first fit, a best fit, and a best-pair technique.

8. The method of managing files according to claim 7 wherein the first fit technique comprises sorting the files that need to be updated in decreasing order of size; and
for each file to be updated after the preprocessing:
determining empty gaps;
modifying the largest file f*ₘₐₓ fitting the largest empty gap gₘₐₓ and creating a new gap of size gₘₐₓ−fₘₐₓ.

9. The method of managing files according to claim 8 wherein, for all the successful updates the one with the smallest E is selected.

10. The method of managing files according to claim 7 wherein the best fit technique comprises sorting the files that need to be updated in decreasing order; and
for each file to be updated after the preprocessing:
determining empty gaps;
the largest file f*ₘₐₓ is updated by using the smallest gap g_{best} having equal or bigger size: g_{best}=arg min (gᵢ−f*ₘₐₓ); and
creating a new gap a new gap of size g_{best}−f*ₘₐₓ.

12. The method of updating wherein for all the successful updates the one with the smallest E is selected.

13. The method of managing files according to claim 7 wherein the best pair technique comprises sorting the files that need to be updated in decreasing order; and
for each file to be updated after the preprocessing until all files are updated:
determining empty gaps;
a pair comprising a file and a gap (f*_{bp},g_{bp}) is selected so that the remaining portion of the gap g_{bp}−f*_{bp} is minimum among all possible pairs;
converting the file fbp into the file f*_{bp} and creating a new gap of size g_{bp}−f*_{bp};

14. The method of updating wherein for all the successful updates the one with the smallest E is selected.
